(19) United States
(12) Patent Application Publication
(10) Pub. No.: US 2025/0068106 A1
(43) Pub. Date: Feb. 27, 2025

(54) IMAGE FORMING APPARATUS

(71) Applicant: FUJIFILM BUSINESS INNOVATION CORP., Tokyo (JP)

(72) Inventors: Yutaka KIUCHI, Kanagawa (JP); Kazuki KISHI, Kanagawa (JP); Hideki KUGE, Kanagawa (JP); Yoshiki SHIMODAIRA, Kanagawa (JP); Takayuki UKAWA, Kanagawa (JP)

(73) Assignee: FUJIFILM BUSINESS INNOVATION CORP., Tokyo (JP)

(21) Appl. No.: 18/587,082

(22) Filed: Feb. 26, 2024

(30) Foreign Application Priority Data
Aug. 21, 2023 (JP) 2023-134206

(51) Int. Cl. G03G 15/00; G03G 15/16; G03G 15/20

(52) U.S. Cl. CPC G03G 15/50; G03G 15/161; G03G 15/2025; G03G 2215/1652; G03G 2221/0005

(57) ABSTRACT

An image forming apparatus includes: a rotatable cylinder; a rotational member rotatable integrally with the cylinder; an annular circumferential rotation member that is wound around the rotational member, and configured to circumferentially rotate along with rotation of the rotational member; a holding member that is mounted on the circumferential rotation member, and configured to rotate along with the circumferential rotation member and hold a front end of a recording medium; a recess provided in an outer circumference of the cylinder, and configured to store the holding member; a cleaning member that is to come into contact with an outer circumferential surface of the cylinder to clean the outer circumferential surface; and a controller that, in a pause period of image formation, controls rotation of the cylinder so that the cleaning member is located at a position of the recess in a rotation direction of the cylinder.

### CROSS-REFERENCE TO RELATED APPLICATIONS

This application is based on and claims priority under 35 USC 119 from Japanese Patent Application No. 2023-134206 filed Aug. 21, 2023.

### BACKGROUND

### (i) Technical Field

The present disclosure relates to an image forming apparatus.

### (ii) Related Art

Japanese Unexamined Patent Application Publication No. 58-005769 discloses a transfer device that transfers an image on an image carrier, the transfer device including: a transfer material transport unit that moves a transfer material endlessly along a circulation movement path; a gripper piece that is mounted on the transport unit, pivotally supported on a rotational shaft, and rotationally moves relative to a stand member to grip the leading edge of the transfer material; and a switch member mounted on the stand member, the transfer device being configured to detect the presence of a transfer material in the gripper by partially notching the switch member position of the gripper piece.

### SUMMARY

Aspects of non-limiting embodiments of the present disclosure relate to reducing deterioration of a cleaning member, as compared to a configuration in which in a pause period of image formation, rotation of a cylinder is controlled so that the cleaning member is located in both areas adjacent to a recess in the rotation direction of the cylinder.

Aspects of certain non-limiting embodiments of the present disclosure address the above advantages and/or other advantages not described above. However, aspects of the non- limiting embodiments are not required to address the advantages described above, and aspects of the non-limiting embodiments of the present disclosure may not address advantages described above.

According to an aspect of the present disclosure, there is provided an image forming apparatus including: a rotatable cylinder; a rotational member rotatable integrally with the cylinder; an annular circumferential rotation member that is wound around the rotational member, and configured to circumferentially rotate along with rotation of the rotational member; a holding member that is mounted on the circumferential rotation member, and configured to rotate along with the circumferential rotation member and hold a front end of a recording medium; a recess provided in an outer circumference of the cylinder, and configured to store the holding member; a cleaning member that is to come into contact with an outer circumferential surface of the cylinder to clean the outer circumferential surface; and a controller that, in a pause period of image formation, controls rotation of the cylinder so that the cleaning member is located at a position of the recess in a rotation direction of the cylinder.

### BRIEF DESCRIPTION OF THE DRAWINGS

Exemplary embodiments of the present disclosure will be described in detail based on the following figures, wherein:

FIG. 1 is a schematic front view of an image forming apparatus in an exemplary embodiment of the present disclosure;

FIG. 2 is a perspective view illustrating a chain gripper according to the exemplary embodiment of FIG. 1;

FIG. 3 is a perspective view illustrating an opposed roller and a second transfer roller according to the exemplary embodiment of FIG. 1;

FIG. 4 is a perspective view illustrating a fixing device according to the exemplary embodiment of FIG. 1;

FIG. 5 is an enlarged view of the portion indicated by arrow 5X of FIG. 1, and schematically illustrates the positional relationship between a recess of a transfer cylinder and a cleaning brush of a first cleaning device during printing;

FIG. 6 is an enlarged view corresponding to FIG. 5, and schematically illustrates the positional relationship between the recess of the transfer cylinder and the cleaning brush of the first cleaning device in a pause period;

FIG. 7 is an enlarged view corresponding to FIG. 5 for explaining the operation of self- cleaning of the first cleaning device in an inactive period;

FIG. 8 is an enlarged view of the portion indicated by arrow 8X of FIG. 1, and schematically illustrates the positional relationship between a recess of a fixing cylinder and a cleaning member of a second cleaning device during printing;

FIG. 9 is an enlarged view corresponding to FIG. 8, and schematically illustrates the positional relationship between the recess of the fixing cylinder and the cleaning member of the second cleaning device in a pause period;

FIG. 10 is an enlarged view corresponding to FIG. 8 for explaining the operation of changing the cleaning surface of the cleaning member of the second cleaning device in an inactive period;

FIG. 11 is a block diagram illustrating an example of a functional configuration of a control device according to the exemplary embodiment of FIG. 1;

FIG. 12 is a flowchart illustrating the rotational operation of the fixing cylinder and the transfer cylinder in an inactive period; and

FIG. 13 is a flowchart illustrating the rotational operation of the fixing cylinder and the transfer cylinder in an inactive period.

### DETAILED DESCRIPTION

An example of an image forming apparatus according to an exemplary embodiment of the present disclosure will be described.

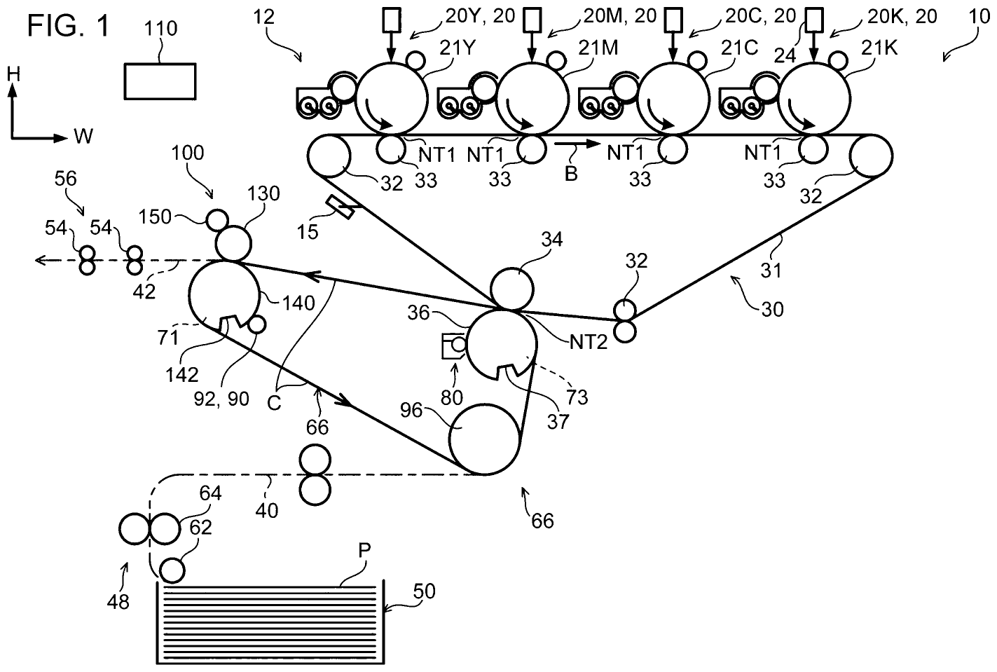

A fixing device and an image forming apparatus according to an exemplary embodiment of the present disclosure will be described based on FIG. 1 to FIG. 13. Note that in the diagrams, arrow H indicates the apparatus up-down direction (vertical direction), arrow W indicates the apparatus width direction (horizontal direction), and arrow D indicates the apparatus depth direction (horizontal direction).

In the drawings, the components shown using the same symbol indicate that they are the same or similar components. Note that in the exemplary embodiment described below, repeated description and symbols may be omitted. The drawings used in the following description are all schematic, and the relationship between the dimensions of the elements, and the ratio of each element shown in the drawings do not necessarily reflect to actual ones. Even between multiple drawings, the relationship between the dimensions of the elements, and the ratio of each element shown in the drawings are not necessarily consistent.

### [Image Forming Apparatus 10]

The configuration of an image forming apparatus 10 according to the present exemplary embodiment will be described. FIG. 1 is a schematic front view of the image forming apparatus 10 according to the present exemplary embodiment.

The image forming apparatus 10 according to the present exemplary embodiment is an electrophotographic image forming apparatus that forms a toner image on a sheet member P based on image information input to the apparatus. Note that the sheet member P is an example of a recording medium, and the toner image is an example of an image. As illustrated in FIG. 1, the image forming apparatus 10 includes a storage 50, a paper feed mechanism 48, an image former 12, a transfer unit 30, a fixing unit 100, and a paper ejection mechanism 56. In addition, the image forming apparatus 10 further includes a control device 110 that outputs control information to control the operation of each component based on the image information input to the apparatus and detection results by sensors. Note that the control device 110 is an example of a controller.

The storage 50 has a function of storing sheet members P. As illustrated in FIG. 1, the image forming apparatus 10 includes the storage 50. Each sheet member P is delivered from the storage 50. As the sheet member P, for example, sheet paper (so-called cut sheet) having predetermined dimensions (in other words, size) is used. Note that the present disclosure is not limited to this configuration. For example, the image forming apparatus 10 may include a plurality of storages 50. In this case, each sheet member P is delivered selectively from the plurality of storages 50.

The paper feed mechanism 48 has a function of transporting the sheet members P stored in the storage 50 to the later-described chain gripper 66. Specifically, as illustrated in FIG. 1, the paper feed mechanism 48 includes a delivery roller 62, and a plurality of transport rollers 64 to transport the sheet member P along a paper feed path 40 through which the sheet member P is transported.

As illustrated in FIG. 1, the delivery roller 62 is a roller to deliver a sheet member P stored in the storage 50 to the paper feed path 40. The plurality of transport rollers 64 are rollers to transport, to the chain gripper 66, the sheet member P delivered to the paper feed path 40 by the delivery roller 62.

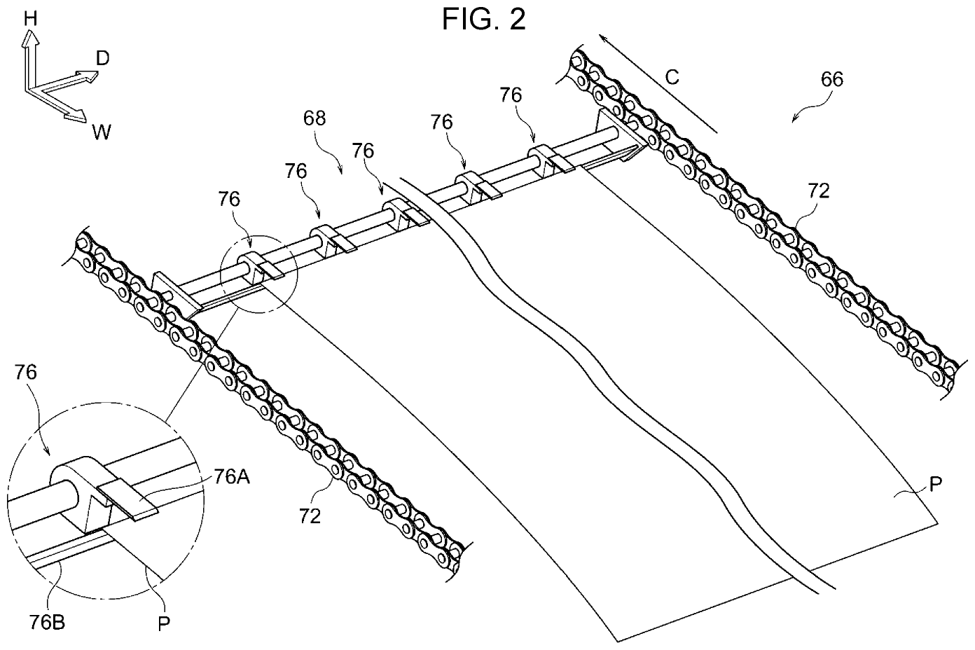

The chain gripper 66 has a function of transporting the sheet member P transported from the paper feed mechanism 48 to a paper ejection path 42 through the transfer unit 30 and the fixing unit 100. Specifically, as illustrated in FIG. 2, the chain gripper 66 holds the front end (in other words, the downstream end of the sheet member P in the transport direction) of the sheet member P to transport the sheet member P to the paper ejection path 42 through the transfer unit 30 and the fixing unit 100. Note that the sheet member P transported to the paper ejection path 42 is transported to an ejection unit (not illustrated) outside the apparatus body by a plurality of transport rollers 54 included in the paper ejection mechanism 56. The chain gripper 66 is an example of a transport unit. As illustrated in FIG. 1, the chain gripper 66 includes a pair of chains 72, sprockets 71, 73, 96, and a grip unit 68 (see FIG. 2) having grippers 76 to grip the leading end of the sheet member P. The chains 72 in the present exemplary embodiment are an example of a circumferential rotation member in the present disclosure. Each gripper 76 in the present exemplary embodiment is an example of a holding member in the present disclosure.

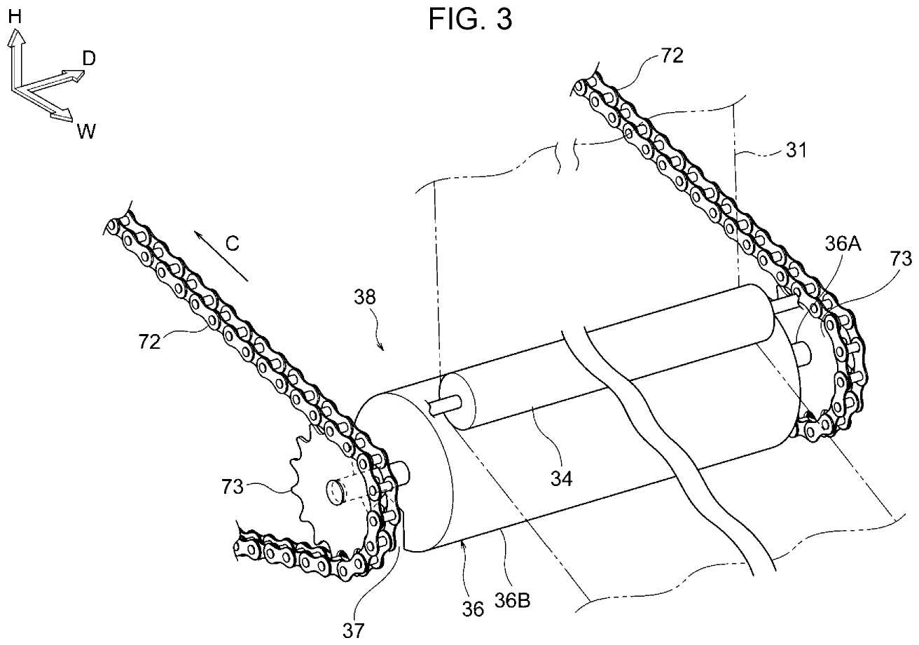

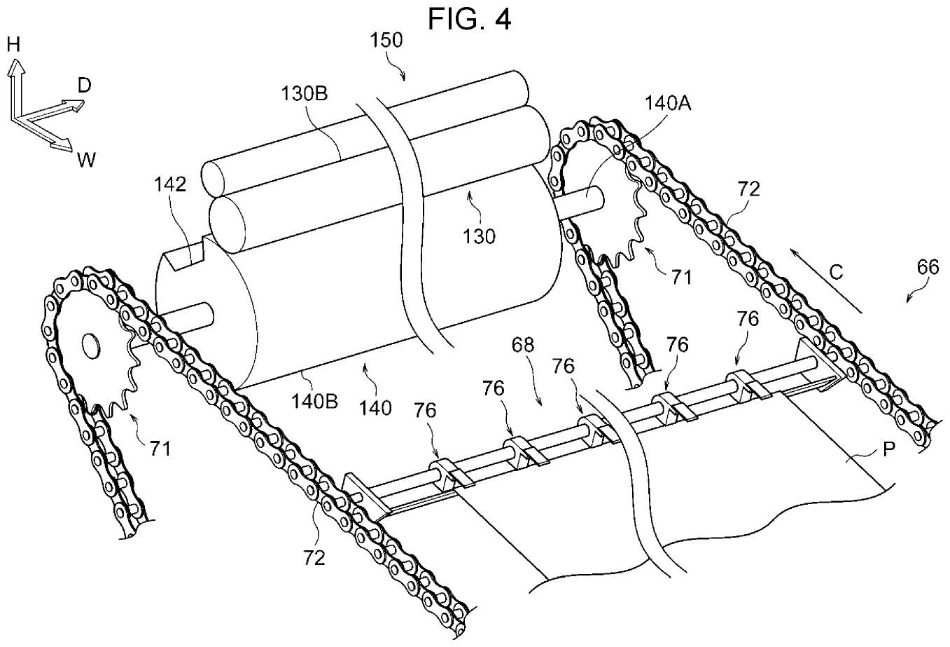

As illustrated in FIG. 2, the pair of chains 72 are disposed at intervals in the apparatus depth direction. As illustrated in FIG. 1, the pair of chains 72 are formed in an endless shape. The pair of chains 72 are each wound around a pair of sprockets 71, 73, 96 which are disposed at intervals in the apparatus depth direction. Note that FIG. 3 illustrates a pair of sprockets 73 which are disposed at intervals in the apparatus depth direction, and FIG. 4 illustrates a pair of sprockets 71 which are disposed at intervals in the apparatus depth direction. The chains 72 are configured to circumferentially rotate in the arrow C direction by rotation of one of these pairs of sprockets 71, 73, 96 (see FIG. 1). In part of the diagrams, teeth provided on the outer circumference of the sprockets 71, 73, 96 are omitted from illustration.

As illustrated in FIG. 2, the grip unit 68 with the grippers 76 mounted is bridged over the pair of chains 72 in the apparatus depth direction. Multiple grip units 68 are fixed to the pair of chains 72 at predetermined intervals in the circumferential direction (circumferential rotation direction C) of the chains 72.

As illustrated in FIG. 2, multiple grippers 76 are mounted on the grip unit 68 at predetermined intervals in the apparatus depth direction. Each gripper 76 has a function of holding (gripping) the front end of the sheet member P. The gripper 76 is an example of a holding member. Specifically, as illustrated in FIG. 2, the gripper 76 has a nail 76A and a nail stand 76B. The gripper 76 is configured to hold the sheet member P by pinching the front end of the sheet member P between the nail 76A and the nail stand 76B. For example, the gripper 76 causes the nail 76A to be pressed against the nail stand 76B by a spring or the like, and opens or closes the nail 76A with respect to the nail stand 76B by the action of a cam or the like. In this manner, in the present exemplary embodiment, the gripper 76 disposed downstream of the transport direction with respect to the sheet member P holds the front end of the sheet member P at a downstream position in the transport direction of the sheet member P.

As illustrated in FIG. 2, the chains 72 circumferentially rotate in arrow C direction with the front end of the sheet member P held by each gripper 76, thus the chain gripper 66 transports the sheet member P with one surface of the sheet member P facing upward. At this point, the chain gripper 66 transports the sheet member P without holding the rear end side part of the sheet member P. In other words, the sheet member P is transported with the rear end side part thereof unrestrained in a free state. In this manner, the sheet member P passes through the transfer unit 30 and the fixing unit 100 with one surface of the sheet member P facing upward.

### [Image Former 12]

The image former 12 has a function of forming an image to be transferred to the sheet member P by an electrophotographic method. The image former 12 includes a plurality of image forming units 20 that form toner images.

The image former 12 has a function of forming an image on the sheet member P as a recording medium at the later-described image formation position of the circumferential rotation path of the chains 72. Specifically, the image former 12 has a function of forming an image on the surface (outer circumferential surface) of the later-described transfer belt 31, and transfers the formed image to the sheet member P at a second transfer position NT2 as an image forming position, thereby forming the image on the sheet member P. As an example, the image former 12 has four image forming units 20. The four image forming units 20 form, for example, toner images of different colors from each other, such as yellow (Y), magenta (M), cyan (C), black (K).

Each image forming unit 20 has a photoconductor drum 21. The photoconductor drum 21 is an example of an image holder, and holds a toner image to be transferred to the sheet member P on the outer circumferential surface, and rotates. The image forming unit 20 has a function of forming a toner image on the photoconductor drum 21 of a corresponding color, and transferring the toner image to the transfer belt 31 at a first transfer position NT1 formed between the photoconductor drum 21 and a first transfer roller 33.

The image forming unit 20 includes a charge device that charges photoconductor drum 21 with electricity, an exposure device that forms a latent image on the charged photoconductor drum 21, and a developer device that develops the latent image by toner.

### [Transfer Unit 30]

As illustrated in FIG. 1, the transfer unit 30 has a function of transferring an image (toner image) formed on the surface of the transfer belt 31 to the sheet member P. Specifically, the transfer unit 30 includes the transfer belt 31 as an example of a transfer body, the first transfer rollers 33, a plurality of rollers 32, a second transfer roller 34, an opposed roller 36 as an example of a cylinder, and a cleaner 15.

As illustrated in FIG. 1, the transfer belt 31 has an endless shape, and is wound and stretched around the plurality of rollers 32 and the second transfer roller 34 to have a posture of an inverted triangle shape in a front view (as seen from the near side in the apparatus depth direction). The transfer belt 31 circumferentially rotates in arrow B direction by rotation of at least one of the plurality of rollers 32. The image forming units 20 of respective colors and the cleaner 15 are disposed on the outer circumferential portion of the transfer belt 31.

A plurality of first transfer rollers 33 are disposed inside the transfer belt 31. The first transfer rollers 33 correspond to respective colors of an image. In other words, in the present exemplary embodiment, four first transfer rollers 33 corresponding to respective colors are disposed. The first transfer rollers 33 are disposed on the opposite side of the photoconductor drums 21 of respective colors with respect to the transfer belt 31.

The second transfer roller 34 is disposed inside the transfer belt 31.

### (Opposed Roller 36)

The opposed roller 36 is disposed on the opposite side of the second transfer roller 34 with respect to the transfer belt 31. As illustrated in FIG. 3, the opposed roller 36 extends in the apparatus depth direction.

As illustrated in FIG. 3, the opposed roller 36 includes a shaft portion 36A extending in the apparatus depth direction, and a roller portion 36B as a cylindrical member provided at an axially intermediate position of the shaft portion 36A. The above-mentioned sprockets 73 are respectively mounted on axially both ends of the shaft portion 36A. In other words, the roller portion 36B of the opposed roller 36 is disposed between a pair of sprockets 73. The sprockets 73 rotate integrally with the opposed roller 36. The sprockets 73 in the present exemplary embodiment are an example of a rotational member in the present disclosure.

In the present exemplary embodiment, the shaft portion 36A of the opposed roller 36 is connected to a drive source (not illustrated). The opposed roller 36 rotates due to the driving force from the drive source. The rotation of the opposed roller 36 causes the chains 72 of the chain gripper 66 to circumferentially rotate via the integrally rotating sprockets 73. Note that the rotation of the opposed roller 36 is synchronized with the rotation the later- described pressure roller 140.

The roller portion 36B of the opposed roller 36 is provided with a recess 37 that can internally store the grippers 76. The recess 37 has a groove-like shape extending in the axial direction (the direction same as the apparatus depth direction) from one end to the other end of the roller portion 36B. The recess 37 in the present exemplary embodiment is an example of a recess and a first recess in the present disclosure.

The opposed roller 36 forms a nip region between itself and the second transfer roller 34 which presses the transfer belt 31 against the opposed roller 36. In other words, the nip region is formed between the opposed roller 36 and the transfer belt 31. The opposed roller 36 which rotates by the driving force from the drive source drags the transfer belt 31 in the nip region. The opposed roller 36 transfers a toner image formed on the transfer belt 31 to the sheet member P, while dragging the transfer belt 31 with the sheet member P transported by the chains 72 and the grippers 76 and nipped between the outer circumferential portion and the transfer belt 31 in the nip region. Note that the nip region formed between the opposed roller 36 and transfer belt 31 is a second transfer position NT2 which is an example of an image forming position. In other words, in the image forming apparatus 10 of the present exemplary embodiment, a toner image formed on the surface of the transfer belt 31 by the image former 12 at the second transfer position NT2 is to be transferred to the surface of the sheet member P wound around the opposed roller 36.

The opposed roller 36 in the present exemplary embodiment is an example of a transfer cylinder.

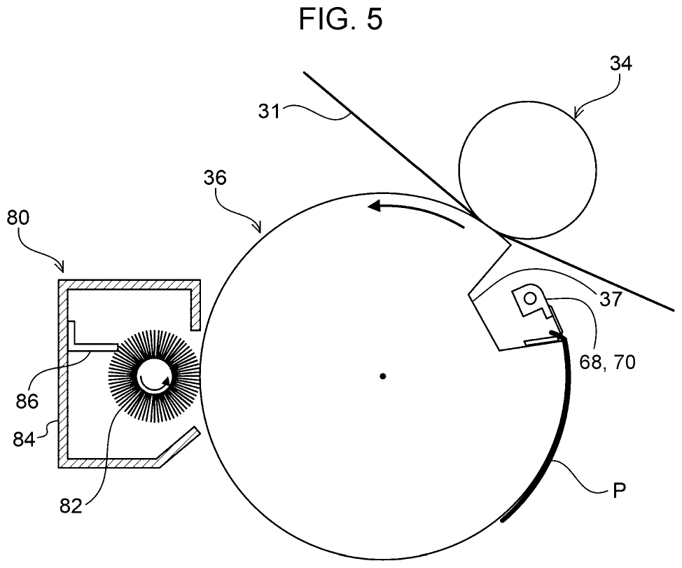

As illustrated in FIG. 5, a first cleaning device 80 is disposed on the outer circumference of the opposed roller 36. Specifically, as illustrated in FIG. 1, the first cleaning device 80 is disposed on the outer circumference of the opposed roller 36 so as to be located in an area which is inside the sprockets 73 and around which the chains 72 of the sprockets 73 are not wound in a front view. As illustrated in FIG. 5, the first cleaning device 80 has a function of cleaning the surface (the outer circumferential surface) of the opposed roller 36. Specifically, the first cleaning device 80 includes a cleaning member that comes into contact with the outer circumferential surface of the opposed roller 36 to clean the outer circumferential surface, and a brush 82 as an example of a first cleaning member. The brush 82 has a roll-shape, and rotates in an opposite direction to the opposed roller 36 at a different speed therefrom, and comes into contact with the outer circumferential surface of the opposed roller 36 to remove the substances (e.g., toner, paper dust, other foreign materials) which have adhered to the outer circumferential surface. More specifically, the brush 82 and the opposed roller 36 rotate in the forward direction at the contact area between the brush 82 and the opposed roller 36, and due to the difference between the rotational speed of the brush 82 and the rotational speed of the opposed roller 36, the brush 82 easily removes the adhering substances from the outer circumferential surface of the opposed roller 36. Note that the outer circumferential surface of the opposed roller 36 in the present exemplary embodiment corresponds to the outer circumferential surface of the roller portion 36B. The length of the brush 82 in the axial direction (depth direction) may be longer than the area of the roller portion 36B to be cleaned. In the present exemplary embodiment, the rotational speed of the brush 82 is set lower than the rotational speed of the opposed roller 36; however, the present disclosure is not limited to this configuration. Note that in the drive source (not illustrated) that drives the brush 82 to rotate, the start, stop, and rotational speed are controlled by the control device 110.

The first cleaning device 80 includes a housing 84, and a contact member 86. The housing 84 internally stores the brush 82 and the contact member 86. In addition, the housing 84 can internally store the toner removed from the opposed roller 36 by the brush 82. The periphery of the brush 82 is provided with the contact member 86 whose base end is fixed to the inner wall of the housing 84 so that the leading end is in contact with the brush 82. The length of the contact member 86 in the depth direction may be approximately the same as the length of the brush 82 so that the toner which has adhered to the brush 82 can be removed. Since the brush 82 rotates in contact with the contact member 86, the toner which has adhered to the brush 82 is removed (falls off) from the brush 82.

### [Fixing Unit 100]

The fixing unit 100 is provided downstream of the second transfer position NT2 in the transport direction of the sheet member P. The fixing unit 100 has a function of fixing a toner image to the sheet member P, the toner image being transferred to the sheet member P by the transfer unit 30.

As illustrated in FIG. 4, the fixing unit 100 includes a heating roller 130 that comes into contact with the transported sheet member P to heat the sheet member P, and a pressure roller 140 as a pressure unit that nips the sheet member P with the heating roller 130 to pressurize the sheet member P toward the heating roller 130.

### (Pressure Roller 140)

The pressure roller 140 has a function of nipping the sheet member P with the heating roller 130 and pressurizing the sheet member P. Specifically, as illustrated in FIG. 4, the pressure roller 140 includes a shaft portion 140A extending in the apparatus depth direction, a roller portion 140B as a cylindrical member provided in the outer circumference of the shaft portion 140A, and a recess 142 provided in the outer surface of the roller portion 140B. The above-mentioned sprockets 71 are respectively mounted on both ends of the shaft portion 140A. The sprockets 71 rotate integrally with the pressure roller 140. The recess 142 in the present exemplary embodiment is an example of a recess and a second recess in the present disclosure. The sprockets 71 in the present exemplary embodiment are an example of a rotational member in the present disclosure.

In the present exemplary embodiment, the shaft portion 140A of the pressure roller 140 is connected to a drive source (not illustrated). The pressure roller 140 rotates by the driving force from the drive source. The rotation of the pressure roller 140 causes the chains 72 of the chain gripper 66 to circumferentially rotate via the integrally rotating sprockets 71. The rotation of the pressure roller 140 is synchronized with the rotation of the opposed roller 36.

As illustrated in FIG. 4, the recess 142 is a recess capable of internally storing the grippers 76 and the grip unit 68, and has a groove-like shape extending in the apparatus depth direction from one end to the other end of the roller portion 140B. The recess 142 is open to the radially outer side of the pressure roller 140.

The pressure roller 140 in the present exemplary embodiment is an example of a fixing cylinder.

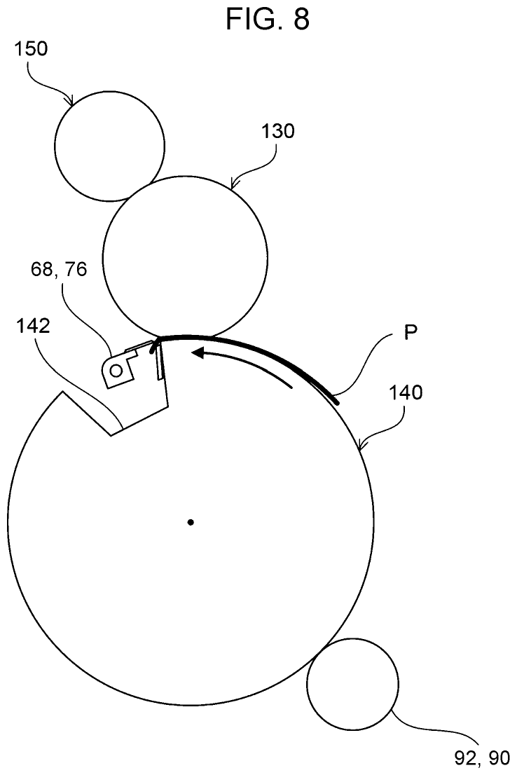

As illustrated in FIG. 8, the outer circumference of the pressure roller 140 is provided with a second cleaning device 90. Specifically, as illustrated in FIG. 1, the second cleaning device 90 is disposed on the outer circumference of the pressure roller 140 so as to be located in an area which is inside the sprockets 71 and around which the chains 72 of the sprockets 71 are not wound in a front view. As illustrated in FIG. 8, the second cleaning device 90 has a function of cleaning the surface (the outer circumferential surface) of the pressure roller 140. Specifically, the second cleaning device 90 includes a cleaning member that comes into contact with the outer circumferential surface of the pressure roller 140 to clean the outer circumferential surface, and a brush 92 as an example of a second cleaning member. The brush 92 is a roll-shaped brush that is rotatable, and comes into contact with the outer circumferential surface of the pressure roller 140 with a fixed rotational position with respect to the pressure roller 140 to remove the foreign materials (such as toner) which have adhered to the outer circumferential surface. Note that the outer circumferential surface of the pressure roller 140 in the present exemplary embodiment corresponds to the outer circumferential surface of the roller portion 140B. The length of the brush 92 in the axial direction (depth direction) may be longer than the area of the roller portion 140B to be cleaned. Even when cleaning of the outer circumferential surface of the pressure roller 140 causes wearing of a contact area with the outer circumferential surface, the cleaning ability of the brush 92 can be restored by rotating the brush 92 by a predetermined angle to change the contact area of the brush 92 with the pressure roller 140. Note that in the drive source (not illustrated) that rotates the brush 92, the start and stop are controlled by the control device 110.

### (Heating Roller 130)

The heating roller 130 has a function of heating the sheet member P. Specifically, as illustrated in FIG. 4, the heating roller 130 includes a shaft portion (not illustrated), and a roller portion 130B formed on the outer circumference of the shaft portion.

The heating roller 130 forms a nip region for nipping the sheet member P with the pressure roller 140 by bringing the outer circumferential surface of the roller portion 130B into contact with the outer circumferential surface of the roller portion 140B of the pressure roller 140.

The fixing unit 100 further includes a heat source roller 150. The heat source roller 150 has a function of heating the heating roller 130. Specifically, the heat source roller 150 comes into contact with the heating roller 130 to heat the heating roller 130.

In the present exemplary embodiment, the pressure roller 140 rotates, and the heating roller 130 and the heat source roller 150 are configured to be driven by the pressure roller 140; however, the present disclosure is not limited to this configuration. For example, the heating roller 130 is driven, and the pressure roller 140 and the heat source roller 150 may be configured to be driven by the heating roller 130. In this case, the rotational force of the pressure roller 140 driven by the heating roller 130 causes the chains 72 of the chain gripper 66 to circumferentially rotate.

As illustrated in FIG. 1, in the fixing unit 100, the sheet member P is nipped by the heating roller 130 and the pressure roller 140, and heated and pressurized, thus the toner image formed on the sheet member P is fixed thereto.

### (Control Device 110)

As described above, the control device 110 has a function of controlling image information input to the image forming apparatus 10, and the components (the storage 50, the paper feed mechanism 48, the image former 12, the transfer unit 30, the fixing unit 100, and the paper ejection mechanism 56) of the image forming apparatus 10. Note that the control device 110 in the present exemplary embodiment is an example of a controller in the present disclosure.

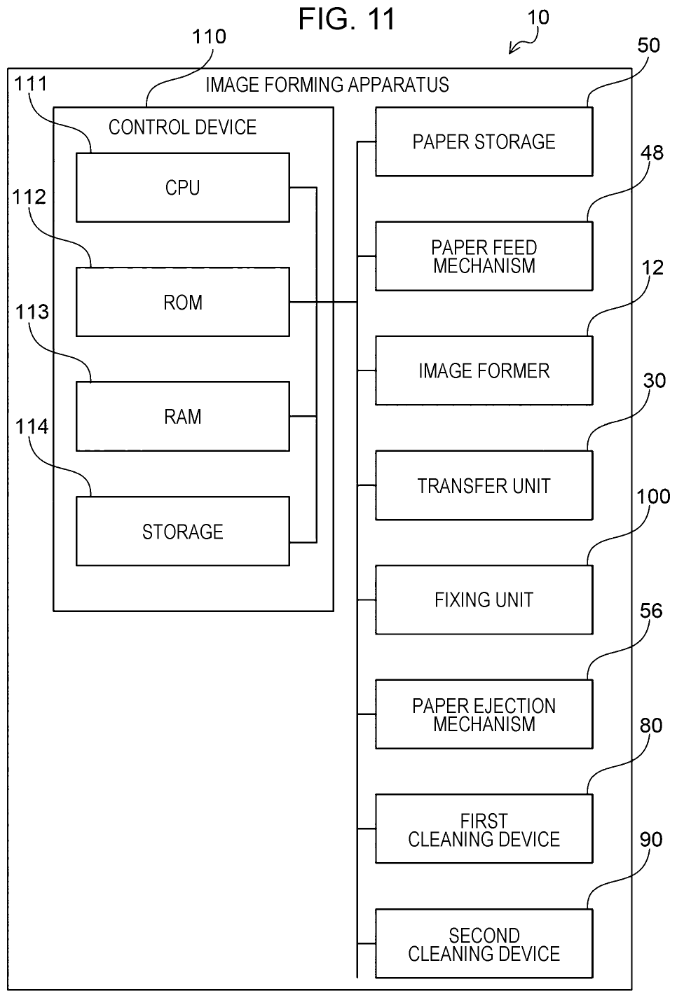

As illustrated in FIG. 11, the control device 110 is constituted by including a central processing unit (CPU) 111, a read only memory (ROM) 112, a random access memory (RAM) 113, and a storage 114.

The CPU 111 is a central calculation processing unit, and executes various programs and controls the components. Specifically, the CPU 111 reads a program from the ROM 112 or the storage 114, and executes the program using the RAM 113 as a work area. The CPU 111 performs control of the above-mentioned components and various calculation processes in accordance with a program recorded in the ROM 112 or the storage 114.

The ROM 112 stores various programs and various data. The RAM 113 as a work area temporarily stores programs or data. The storage 114 is comprised of a hard disk drive (HDD) or a solid state drive (SSD), and stores various programs including the operating system, and various data.

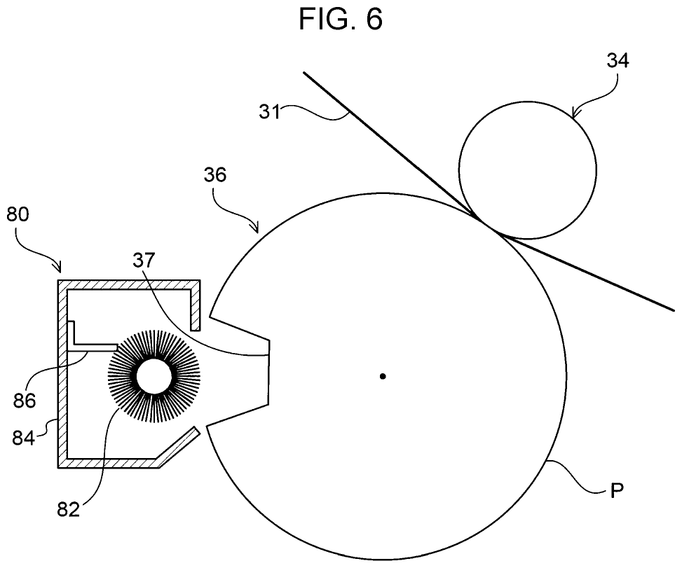

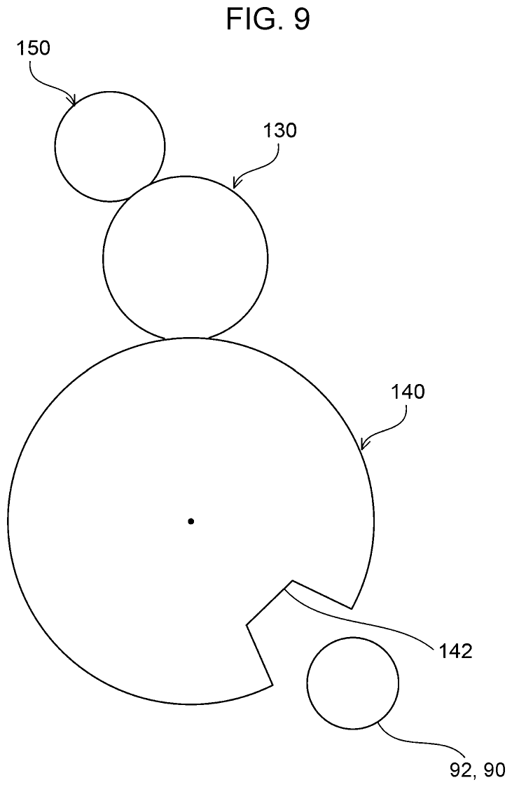

The control device 110 has a first control mode and a second control mode in a pause period of image formation, the first control mode in which as illustrated in FIG. 6, rotation of the opposed roller 36 is controlled so that the brush 82 is located at the position of the recess 37 in the rotation direction of the opposed roller 36, the second control mode in which as illustrated in FIG. 9, rotation of the pressure roller 140 is controlled so that the brush 92 is located at the position of the recess 142 in the rotation direction of the pressure roller 140, and these modes are configured to be switchable. Specifically, in the first control mode, the control device 110 controls the circumferential rotation of the chains 72 so that rotation of the opposed roller 36 is stopped at the position (the rotational position) at which the recess 37 of the opposed roller 36 is opposed to the brush 82. In contrast, in the second control mode, the control device 110 controls the circumferential rotation of the chains 72 so that rotation of the pressure roller 140 is stopped at the position (the rotational position) at which the recess 142 of the pressure roller 140 is opposed to the brush 92.

The rotational position, opposed to the brush 82, of the recess 37 of the opposed roller 36 may be determined from e.g., the number of revolutions of the opposed roller 36, or the position of the recess 37 may be determined by a sensor or the like. In the present exemplary embodiment, as an example, the rotational position, opposed to the brush 82, of the recess 37 of the opposed roller 36 is pre-stored in the ROM 112 or the RAM 113, and when the first control mode is selected, the control device 110 reads the above-mentioned rotational position of the opposed roller 36, and controls the rotation of the opposed roller 36 so that the recess 37 is opposed to the brush 82. Note that in the present exemplary embodiment, the pressure roller 140 is connected to a drive source, thus the control device 110 causes the recess 37 to be opposed to the brush 82 by controlling the rotation of the opposed roller 36. In the present exemplary embodiment, when the recess 37 of the opposed roller 36 is at the position opposed to the brush 82, the brush 82 is in a non-contact state with the opposed roller 36 (sec FIG. 6).

The rotational position, opposed to the brush 92, of the recess 142 of the pressure roller 140 may be determined from e.g., the number of revolutions of the pressure roller 140, or the position of the recess 142 may be determined by a sensor or the like. In the present exemplary embodiment, as an example, the rotational position, opposed to the brush 92, of the recess 142 of the pressure roller 140 is pre-stored in the ROM 112 or the RAM 113, and when the second control mode is selected, the control device 110 reads the above-mentioned rotational position of the pressure roller 140, and controls the rotation of the pressure roller 140 so that the recess 142 is opposed to the brush 92. Note that in the present exemplary embodiment, the pressure roller 140 is connected to a drive source, thus the control device 110 causes the recess 142 to be opposed to the brush 92 by controlling the rotation of the pressure roller 140. In the present exemplary embodiment, when the recess 142 of the pressure roller 140 is at the position opposed to the brush 92, the brush 92 is in a non-contact state with the pressure roller 140 (see FIG. 9).

Note that the pause period of image formation in the image forming apparatus 10 refers to the period during which image formation is paused, in other words, the period during which the chains 72 do not circumferentially rotate, and the pause period includes a stand-by period between print jobs and an inactive period (as an example, an inactive period at night) in which part of the power supply to the apparatus is cut-off.

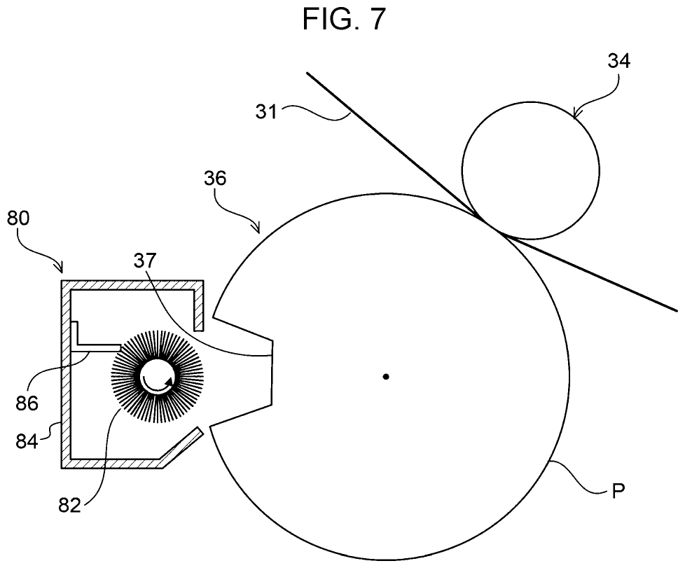

Alternatively, in a pause period of image formation, when the recess 37 of the opposed roller 36 is at a rotational position opposed to the brush 82, the control device 110 may rotate the brush 82 to remove the toner which has adhered to the brush 82 as illustrated in FIG. 7. Specifically, the control device 110 may rotate the brush 82 to cause it to come into contact with the leading end of the contact member 86, and may remove the toner which has adhered to the brush 82.

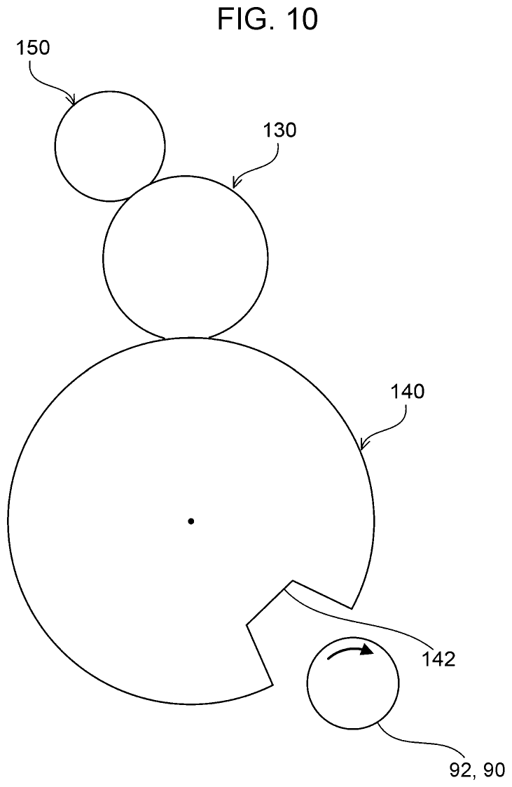

Also, in a pause period of image formation, when the recess 142 of the pressure roller 140 is at a rotational position opposed to the brush 92, the control device 110 may change the contact area of the brush 92 with the pressure roller 140 by rotating the brush 92 as illustrated in FIG. 10. Specifically, the control device 110 may rotate the brush 92 by a predetermined angle to cause unused portion of the brush 92 to come into contact with the outer circumferential surface of the pressure roller 140.

Alternatively, in a pause period of image formation, the control device 110 may switch between the first control mode and the second control mode so that the sum of times when the brush 82 is located at the position of the recess 37 in the rotation direction of the opposed roller 36 is longer than the sum of times when the brush 92 is located at the position of the recess 142 in the rotation direction of the pressure roller 140. For example, in an inactive period of the image forming apparatus 10, the control device 110 may control switching between the first control mode and the second control mode so that the sum of times when the recess 37 of the opposed roller 36 stays at a rotational position opposed to the brush 82 is longer than the sum of times when the recess 142 of the pressure roller 140 stays at a rotational position opposed to the brush 92.

Alternatively, in a pause period of image formation, the control device 110 may switch between the first control mode and the second control mode so that the time when the brush 82 is located at the position of the recess 37 in the rotation direction of the opposed roller 36 is longer than the time when the brush 92 is located at the position of the recess 142 in the rotation direction of the pressure roller 140. For example, in an inactive period of the image forming apparatus 10, the control device 110 may control switching between the first control mode and the second control mode so that the time (time per one stay) when the recess 37 of the opposed roller 36 stays at a rotational position opposed to the brush 82 is longer than the time (time per one stay) when the recess 142 of the pressure roller 140 stays at a rotational position opposed to the brush 92.

When a pause period of image formation starts, the control device 110 may perform the first control mode earlier than the second control mode. For example, when a pause period of image formation starts, the control device 110 may first perform the first control mode, and subsequently may perform the second control mode.

Alternatively, the control device 110 may switch between the first control mode and the second control mode in an inactive period of image formation.

Next, the operation of the image forming apparatus 10 in a pause period of image formation in the present exemplary embodiment will be described.

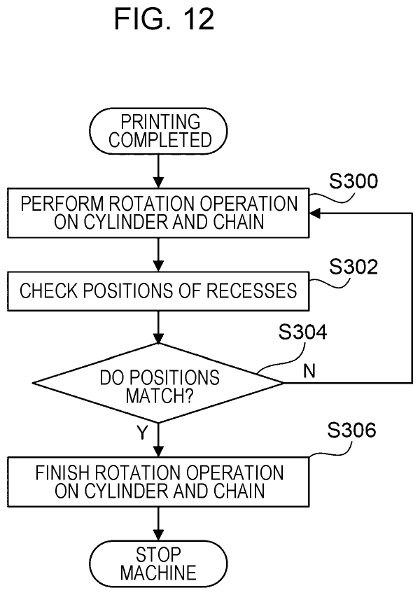

For example, in the case where when the recess 37 of the opposed roller 36 is at a position opposed to the brush 82, the recess 142 of the pressure roller 140 is at a position opposed to the brush 92, the control device 110 determines the operation of the chains 72 in a pause period of image formation in accordance with the flowchart illustrated in FIG. 12. Specifically, when printing is finished in the image forming apparatus 10, the control device 110 rotates the pressure roller 140 and the opposed roller 36 (step S300). Next, the positions of the recess 142 of the pressure roller 140 and the recess 37 of the opposed roller 36 are checked (step S302). It is determined whether the recess 142 of the pressure roller 140 is opposed to the brush 92 and whether the recess 37 of the opposed roller 36 is opposed to the brush 82 (step S304). When the recess 142 of the pressure roller 140 is opposed to the brush 92, and the recess 37 of the opposed roller 36 is opposed to the brush 82, the flow proceeds to step S306, and when the recesses are not opposed to the brushes, the flow proceeds to step S300. In step S306, the rotation of the pressure roller 140 and the opposed roller 36 is finished. The image forming apparatus 10 is stopped. Note that in the example of FIG. 12, when the recess 37 is at a position opposed to the brush 82, the recess 142 is at a position opposed to the brush 92, thus the rotation of one of the pressure roller 140 or the opposed roller 36 may be controlled.

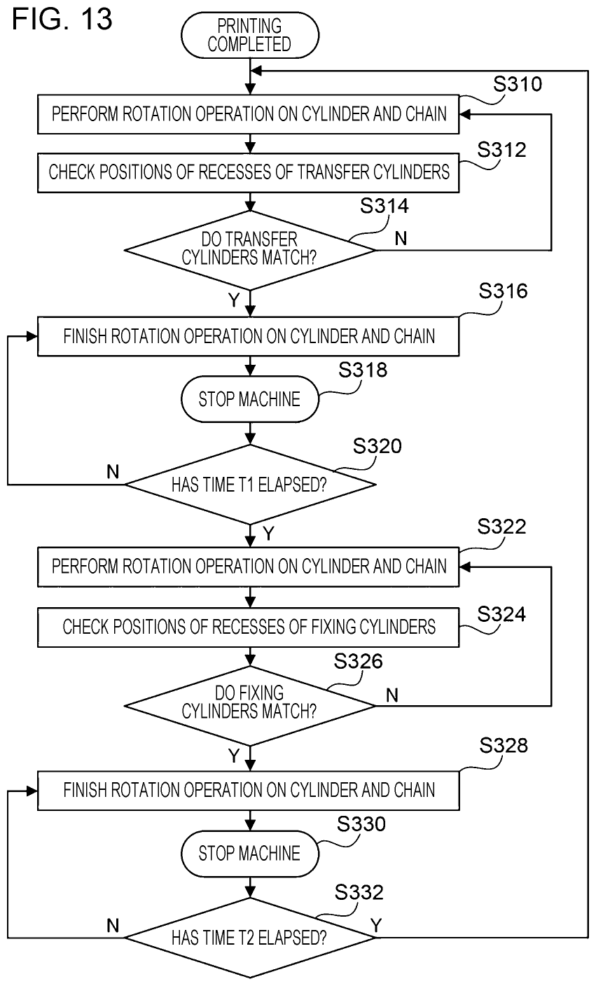

For example, in the case where when the recess 37 of the opposed roller 36 is at a position opposed to the brush 82, the recess 142 of the pressure roller 140 is not at a position opposed to the brush 92, the control device 110 determines the operation of the opposed roller 36 and the pressure roller 140 in a pause period of image formation in accordance with the flowchart illustrated in FIG. 13. Specifically, when printing is finished in the image forming apparatus 10, the control device 110 rotates the pressure roller 140 and the opposed roller 36 (step S310). Subsequently, the position of the recess 37 of the opposed roller 36 is checked (step S312). It is then determined whether the recess 37 of the opposed roller 36 is opposed to the brush 38 (step S314). When the recess 37 of the opposed roller 36 is opposed to the brush 82, the flow proceeds to step S316, and when not opposed, the flow proceeds to step S310. In step S316, the rotation of the pressure roller 140 and the opposed roller 36 is finished. The image forming apparatus 10 is then stopped (step S318). Subsequently, it is determined whether a predetermined time T1 has elapsed (step S320). When the predetermined time T1 has not elapsed, the flow proceeds to step S316, and when the predetermined time T1 has clapsed, the flow proceeds to step S322. In step S322, the control device 110 rotates the pressure roller 140 and the opposed roller 36. Subsequently, the position of the recess 142 of the pressure roller 140 is checked (step S324). It is determined whether the recess 142 of the pressure roller 140 is opposed to the brush 92 (step S326). When the recess 142 of the pressure roller 140 is opposed to the brush 92, the flow proceeds to step S328, and when not opposed, the flow proceeds to step S322. In step S328, rotation of the pressure roller 140 and the opposed roller 36 is finished. The image forming apparatus 10 is then stopped (step S330). Subsequently, it is determined whether a predetermined time T2 has elapsed (step S332). When the predetermined time T2 has not elapsed, the flow proceeds to step S328, and when the predetermined time T2 has elapsed, the flow proceeds to step S310. Like this, in a pause period of image formation, the control device 110 switches between the first control mode (step S310 to step S316) and the second control mode (step S322 to step S328) after elapse of a predetermined time to prevent aged deterioration (wearing) of the brush 82 and the brush 92.

Next, the effect of the present exemplary embodiment will be described. In the image forming apparatus 10, in a pause period of image formation, the rotation of the opposed roller 36 is controlled so that the brush 82 is located at the position of the recess 37 in the rotation direction of the opposed roller 36. Therefore, in the image forming apparatus 10, deterioration (wearing) of the brush 82 can be reduced, as compared to a configuration in which the rotation of the opposed roller 36 is controlled so that the brush 82 is located, for example, in both areas adjacent to the recess 37 in the rotation direction of the opposed roller 36. In the image forming apparatus 10, dirt on the back surface of the sheet member P caused by the brush 82 can be reduced, as compared to a configuration in which the brush 82 continues to be in contact with the opposed roller 36 in a pause period of image formation.

In the image forming apparatus 10, in a pause period of image formation, the control device 110 rotates the brush 82 to remove the toner which has adhered to the brush 82. Therefore, in the image forming apparatus 10, the toner which has adhered to the brush 82 can be removed, and dirt on the back surface of the sheet member P caused by the brush 82 can be prevented, as compared to a configuration in which the brush 82 continues to be paused during a pause period of image formation.

In the image forming apparatus 10, in a pause period of image formation, rotation of the pressure roller 140 is controlled so that the brush 92 is located at the position of the recess 142 in the rotation direction of the pressure roller 140. Therefore, in the image forming apparatus 10, deterioration (wearing) of the brush 92 can be reduced, as compared to a configuration in which the rotation of the pressure roller 140 is controlled so that the brush 92 is located, for example, in both areas adjacent to the recess 142 in the rotation direction of the pressure roller 140. In the image forming apparatus 10, dirt on the back surface of the sheet member P caused by the brush 92 can be reduced, as compared to a configuration in which the brush 92 continues to be in contact with the pressure roller 140 in a pause period of image formation.

In the image forming apparatus 10, in a pause period of image formation, the control device 110 rotates the brush 92 to change the contact area of the brush 92 with the pressure roller 140. Therefore, in the image forming apparatus 10, dirt on the back surface of the sheet member P caused by the brush 92 can be prevented, as compared to a configuration in which the contact area of the brush 92 with the pressure roller 140 is not changed in a pause period of image formation.

In the image forming apparatus 10, in a pause period of image formation, the control device 110 switches between the first control mode and the second control mode, the first control mode in which rotation of the opposed roller 36 is controlled so that the brush 82 is located at the position of the recess 37 in the rotation direction of the opposed roller 36, the second control mode in which rotation of the pressure roller 140 is controlled so that the brush 92 is located at the position of the recess 142 in the rotation direction of the pressure roller 140. Therefore, in the image forming apparatus 10, deterioration of each of the brush 82 and the brush 92 can be reduced, as compared to a configuration in which the control device 110 has only one of the first control mode or the second control mode, for example. Therefore, dirt on the back surface of the sheet member P can be prevented and the number of operations to replace a brush due to deterioration of each of the brush 82 and the brush 92 can be reduced.

In image forming apparatus 10, in a pause period of image formation, the control device 110 switches between the first control mode and the second control mode so that the sum of times when the brush 82 is located at the position of the recess 37 in the rotation direction of the opposed roller 36 is longer than the sum of times when the brush 92 is located at the position of the recess 142 in the rotation direction of the pressure roller 140. Therefore, in the image forming apparatus 10, deterioration of the brush 82 can be reduced, as compared to a configuration in which the sum of times when the brush 82 is located at the position of the recess 37 in the rotation direction of the opposed roller 36 is shorter than the sum of times when the brush 92 is located at the position of the recess 142 in the rotation direction of the pressure roller 140. As an environment, toner is more likely to adhere to the outer circumferential surface of the opposed roller 36 than the outer circumferential surface of the pressure roller 140, thus from the viewpoint of reducing dirt on the back surface of the sheet member P, deterioration of the brush 82 may be reduced.

In the image forming apparatus 10, in a pause period of image formation, the control device 110 switches between the first control mode and the second control mode so that the time when the brush 82 is located at the position of the recess 37 in the rotation direction of the opposed roller 36 is longer than the time when the brush 92 is located at the position of the recess 142 in the rotation direction of the pressure roller 140. Therefore, in the image forming apparatus 10, deterioration of the brush 82 can be reduced, as compared to a configuration in which the time when the brush 82 is located at the position of the recess 37 in the rotation direction of the opposed roller 36 is shorter than the time when the brush 92 is located at the position of the recess 142 in the rotation direction of the pressure roller 140.

In the image forming apparatus 10, when a pause period of image formation starts, the control device 110 performs the first control mode earlier than the second control mode. Therefore, in the image forming apparatus 10, deterioration of the brush 82 can be reduced, as compared to a configuration in which when a pause period starts, the second control mode is performed earlier than the first control mode.

In the image forming apparatus 10, in an inactive period of image formation, the control device 110 switches between the first control mode and the second control mode. Therefore, dirt on the back surface of the sheet member P caused by the brush 82 and the brush 92 can be prevented and the number of operations to replace a brush due to deterioration of each of the brush 82 and the brush 92 can be reduced, as compared to a configuration in which the first control mode and the second control mode are switched at the finish time of a print job during activation of the image forming apparatus 10.

### (Other Exemplary Embodiments)

In the above-described exemplary embodiment, the control device 110 switches the first control mode and the second control mode with time; however, the present disclosure is not limited to this configuration. The control device 110 may perform only one of the first control mode or the second control mode in a pause period of image formation.

In the above-described exemplary embodiment, a configuration is adopted in which the opposed roller 36 and the pressure roller 140 rotate in synchronization; however, the present disclosure is not limited to this configuration. For example, a configuration may be adopted in which one of the opposed roller 36 or the pressure roller 140 is connected to a drive source. In this case, a roller not connected to a drive source rotates driven by the circumferential rotation of the chains 72. Specifically, the rotation of a roller not connected to a drive source can be controlled via the chains 72 by controlling the rotation of a roller connected to a drive source so that the brush is located at the position opposed to the recess of the roller not connected to a drive source.

In the above-described exemplary embodiment, as the image former 12, an electrophotographic image former is used, which forms an image on a recording medium using toner; however, the present disclosure is not limited to this configuration. For example, as the image former, an inkjet image former may be used, which forms an image on a recording medium using an ink.

In the above-described exemplary embodiment, as illustrated in FIG. 5, the first cleaning device 80 is disposed on the outer circumference of the opposed roller 36, and as illustrated in FIG. 8, the second cleaning device 90 is disposed on the outer circumference of the pressure roller 140; however, the present disclosure is not limited to this configuration. The second cleaning device 90 may be disposed on the outer circumference of the opposed roller 36, and the first cleaning device 80 may be disposed on the outer circumference of the pressure roller 140. In this case, when the recess 37 of the opposed roller 36 is located at a rotational position opposed to the brush 92 in a pause period of image formation, the control device 110 may rotate the brush 92 to change the contact area of the brush 92 with the opposed roller 36, and when the recess 142 of the pressure roller 140 is located at a rotational position opposed to the brush 82 in a pause period of image formation, the control device 110 may rotate the brush 82 to remove the toner which has adhered to the brush 82.

The present disclosure is not limited to the above exemplary embodiments, and various modifications, changes, and improvements may be made within a scope not departing from the gist of the present disclosure. For example, some of the modifications shown above may be combined as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### <Appendix>

(((1)))

An image forming apparatus comprising:
a rotatable cylinder;
a rotational member rotatable integrally with the cylinder;
an annular circumferential rotation member that is wound around the rotational member, and configured to circumferentially rotate along with rotation of the rotational member;
a holding member that is mounted on the circumferential rotation member, configured to rotate along with the circumferential rotation member, and upon arrival of a front end of a recording medium to a hold position, hold the front end;
a recess provided in an outer circumference of the cylinder, and configured to store the holding member;
a cleaning member that is to come into contact with an outer circumferential surface of the cylinder to clean the outer circumferential surface; and
a controller that, in a pause period of image formation, controls rotation of the cylinder so that the cleaning member is located at a position of the recess in a rotation direction of the cylinder.
   (((2)))

The image forming apparatus according to (((1))),
wherein the cylinder is a transfer cylinder.
   (((3)))

The image forming apparatus according to (((1))),
wherein the cleaning member is a roll-shaped brush that rotates in an opposite direction to the transfer cylinder at a speed different from a speed of the transfer cylinder, and comes into contact with an outer circumferential surface of the transfer cylinder to remove toner,
a periphery of the brush is provided with a contact member to be in contact with the brush, and
in the pause period, the controller rotates the brush to remove the toner which has adhered to the brush.
   (((4)))

The image forming apparatus according to (((1))),
wherein the cylinder is a fixing cylinder.
   (((5)))

The image forming apparatus according to (((4))),
wherein the cleaning member is a roll-shaped brush that is rotatable, and comes into contact with an outer circumferential surface of the fixing cylinder to remove toner with a fixed rotational position with respect to the fixing cylinder, and
in the pause period, the controller rotates the brush to change an area of the brush, the area to be in contact with the fixing cylinder.
   (((6)))

The image forming apparatus according to (((1))),
wherein the cleaning member is a roll-shaped brush that rotates in an opposite direction to the cylinder at a speed different from a speed of the cylinder, and comes into contact with an outer circumferential surface of the cylinder to remove toner, a periphery of the brush is provided with a contact member to be in contact with the brush, and
in the pause period, the controller rotates the brush to remove the toner which has adhered to the brush.
   (((7)))

The image forming apparatus according to (((1))),
wherein the cleaning member is a roll-shaped brush that is rotatable, and comes into contact with an outer circumferential surface of the cylinder to remove toner with a fixed rotational position with respect to the cylinder, and
in the pause period, the controller rotates the brush to change an area of the brush, the area to be in contact with the cylinder.
   (((8)))

The image forming apparatus according to (((1))),
wherein the cylinder includes a transfer cylinder and a fixing cylinder,
the cleaning member includes a first cleaning member for the transfer cylinder and a second cleaning member for the fixing cylinder,
the recess includes a first recess provided in the transfer cylinder, and a second recess provided in the fixing cylinder,
the circumferential rotation member is wound around the transfer cylinder and the fixing cylinder, and
in the pause period, the controller switches between a first control mode and a second control mode, the first control mode in which rotation of the transfer cylinder is controlled so that the first cleaning member is located at a position of the first recess in a rotation direction of the transfer cylinder, the second control mode in which rotation of the fixing cylinder is controlled so that the second cleaning member is located at a position of the second recess in a rotation direction of the fixing cylinder.
   (((9)))

The image forming apparatus according to (((8))),
wherein in the pause period, the controller switches between the first control mode and the second control mode so that a sum of times when the first cleaning member is located at the position of the first recess in the rotation direction of the transfer cylinder is longer than a sum of times when the second cleaning member is located at the position of the second recess in the rotation direction of the fixing cylinder.
   (((10)))

The image forming apparatus according to (((8))),
wherein in the pause period, the controller switches between the first control mode and the second control mode so that a time when the first cleaning member is located at the position of the first recess in the rotation direction of the transfer cylinder is longer than a time when the second cleaning member is located at the position of the second recess in the rotation direction of the fixing cylinder.
   (((11)))

The image forming apparatus according to any one of (((8))) to (((10))),
wherein when the pause period starts, the controller performs the first control mode earlier than the second control mode.
   (((12)))

The image forming apparatus according to any one of (((8))) to (((11))),
wherein the pause period of image formation includes an inactive period of the apparatus, and
in the inactive period, the controller switches between the first control mode and the second control mode.

What is claimed is:

1. An image forming apparatus comprising:
a rotatable cylinder;
a rotational member rotatable integrally with the cylinder;
an annular circumferential rotation member that is wound around the rotational member, and configured to circumferentially rotate along with rotation of the rotational member;
a holding member that is mounted on the circumferential rotation member, and configured to rotate along with the circumferential rotation member and hold a front end of a recording medium;
a recess provided in an outer circumference of the cylinder, and configured to store the holding member;
a cleaning member that is to come into contact with an outer circumferential surface of the cylinder to clean the outer circumferential surface; and
a controller that, in a pause period of image formation, controls rotation of the cylinder so that the cleaning member is located at a position of the recess in a rotation direction of the cylinder.

2. The image forming apparatus according to claim 1,
wherein the cylinder is a transfer cylinder.

3. The image forming apparatus according to claim 2,
wherein the cleaning member is a roll-shaped brush that rotates in an opposite direction to the transfer cylinder at a speed different from a speed of the transfer cylinder, and comes into contact with an outer circumferential surface of the transfer cylinder to remove toner,
a periphery of the brush is provided with a contact member to be in contact with the brush, and
in the pause period, the controller rotates the brush to remove the toner which has adhered to the brush.

4. The image forming apparatus according to claim 1, wherein the cylinder is a fixing cylinder.

5. The image forming apparatus according to claim 4,
wherein the cleaning member is a roll-shaped brush that is rotatable, and comes into contact with an outer circumferential surface of the fixing cylinder to remove toner with a fixed rotational position with respect to the fixing cylinder, and
in the pause period, the controller rotates the brush to change an area of the brush, the area to be in contact with the fixing cylinder.

6. The image forming apparatus according to claim 1,
wherein the cleaning member is a roll-shaped brush that rotates in an opposite direction to the cylinder at a speed different from a speed of the cylinder, and comes into contact with an outer circumferential surface of the cylinder to remove toner,
a periphery of the brush is provided with a contact member to be in contact with the brush, and
in the pause period, the controller rotates the brush to remove the toner which has adhered to the brush.

7. The image forming apparatus according to claim 1,
wherein the cleaning member is a roll-shaped brush that is rotatable, and comes into contact with an outer circumferential surface of the cylinder to remove toner with a fixed rotational position with respect to the cylinder, and
in the pause period, the controller rotates the brush to change an area of the brush, the area to be in contact with the cylinder.

8. The image forming apparatus according to claim 1,
wherein the cylinder includes a transfer cylinder and a fixing cylinder,
the cleaning member includes a first cleaning member for the transfer cylinder and a second cleaning member for the fixing cylinder,
the recess includes a first recess provided in the transfer cylinder, and a second recess provided in the fixing cylinder,
the circumferential rotation member is wound around the transfer cylinder and the fixing cylinder, and
in the pause period, the controller switches between a first control mode and a second control mode, the first control mode in which rotation of the transfer cylinder is controlled so that the first cleaning member is located at a position of the first recess in a rotation direction of the transfer cylinder, the second control mode in which rotation of the fixing cylinder is controlled so that the second cleaning member is located at a position of the second recess in a rotation direction of the fixing cylinder.

9. The image forming apparatus according to claim 8,
wherein in the pause period, the controller switches between the first control mode and the second control mode so that a sum of times when the first cleaning member is located at the position of the first recess in the rotation direction of the transfer cylinder is longer than a sum of times when the second cleaning member is located at the position of the second recess in the rotation direction of the fixing cylinder.

10. The image forming apparatus according to claim 8,
wherein in the pause period, the controller switches between the first control mode and the second control mode so that a time when the first cleaning member is located at the position of the first recess in the rotation direction of the transfer cylinder is longer than a time when the second cleaning member is located at the position of the second recess in the rotation direction of the fixing cylinder.

11. The image forming apparatus according to claim 8,
wherein when the pause period starts, the controller performs the first control mode earlier than the second control mode.

12. The image forming apparatus according to claim 8,
wherein the pause period of image formation includes an inactive period of the apparatus, and
in the inactive period, the controller switches between the first control mode and the second control mode.

13. The image forming apparatus according to claim 9,
wherein the pause period of image formation includes an inactive period of the apparatus, and
in the down period, the controller switches between the first control mode and the second control mode.

14. The image forming apparatus according to claim 10,
wherein the pause period of image formation includes an inactive period of the apparatus, and
in the down period, the controller switches between the first control mode and the second control mode.

15. The image forming apparatus according to claim 11,
wherein the pause period of image formation includes an inactive period of the apparatus, and
in the down period, the controller switches between the first control mode and the second control mode.

16. An image forming apparatus comprising:
rotatable cylinder means;
rotational means rotatable integrally with the cylinder means;
annular circumferential rotation means for being wound around the rotational means, and circumferentially rotating along with rotation of the rotational means;
holding means for being mounted on the circumferential rotation means, and rotating along with the circumferential rotation means and holding a front end of a recording medium;
recess means for being provided in an outer circumference of the cylinder, and storing the holding means;
cleaning means for coming into contact with an outer circumferential surface of the cylinder means to clean the outer circumferential surface; and
controller means for, in a pause period of image formation, controlling rotation of the cylinder means so that the cleaning means is located at a position of the recess means in a rotation direction of the cylinder means.
